(19) United States
(12) Patent Application Publication
(10) Pub. No.: US 2003/0151919 A1
(43) Pub. Date: Aug. 14, 2003

(54) Bulb cooling

(75) Inventor: Matt Beaumont, Ipswich (GB)

Correspondence Address: FISH & RICHARDSON, PC, 4350 LA JOLLA VILLAGE DRIVE, SUITE 500, SAN DIEGO, CA, 92122, US

(73) Assignee: Light and Sound Design Ltd.

(21) Appl. No.: 10/389,466

(22) Filed: Mar. 13, 2003

Related U.S. Application Data
(62) Division of application No. 09/778,991, filed on Feb. 1, 2001, now Pat. No. 6,578,991.
(60) Provisional application No. 60/179,981, filed on Feb. 3, 2000.

(51) Int. Cl. F21K 2/00

(52) U.S. Cl. 362/264; 362/294; 362/345

(57) ABSTRACT

A system and method of cooling a bulb of a type that requires cooling in one part, but not in others. A deflector assembly is coupled through a reflector, to the bulb, to cool only one part.

### CROSS-REFERENCE TO RELATED APPLICATIONS

The present application is a divisional of U.S. application Ser. No. 09/778,991, filed Feb. 1, 2001, which claims benefit to U.S. provisional application serial No. 60/179,981, filed Feb. 3, 2000.

### BACKGROUND

The present application relates for special techniques for cooling a special kind of bulb.

Special metal halide bulbs have special cooling requirements. The bulbs, such as Philips metal halide projection lamps, often have a central portion which emits light, and two “pinch” portions around the central portion.

A diagram of an exemplary one of these bulbs is shown in FIG. 1. The bulb has a central light emitting portion 100, and the two surrounding “pinch” portions 102, 104.

In some bulbs, it is desirable to keep the pinch portions 102, 104 cooler than the center portion. This is easy to do in a laboratory condition, but more difficult to do in practice.

### SUMMARY

While it may be possible easy to cool only an edge and not the center in a laboratory, the inventor recognized that doing this in practicality can be more difficult. For example, in a laboratory, the bulbs are often cooled using pipes of air. Those pipes could get in the way of the light output from the bulb, and/or the bulb's reflector. Therefore, it has been difficult to cool these kinds of bulbs.

The present application teaches a way of cooling a bulb of this type, by cooling only a pinch portion, and not the center portion. This is done by using a special combination of structure that cools at least one of the edges, but does not cool the center.

### BRIEF DESCRIPTION OF THE DRAWINGS

These and other aspects will be described in detail with reference to the drawings in which:

FIG. 1 shows a pinch-type bulb;

FIG. 2 shows the bulb relative to a portion of the reflector;

FIG. 3 shows the rear of the reflector and the fan assembly;

FIG. 4 show the bulb/reflector from the bottom, showing the special interface piece;

FIG. 5 shows air flow over the pinch, from the side;

FIG. 6 shows air flow over the pinch from the orthogonal direction as FIG. 5;

FIG. 7 shows the bulb with the reflector removed;

FIG. 8 shows the air interface assembly.

### DESCRIPTION OF THE PREFERRED EMBODIMENT

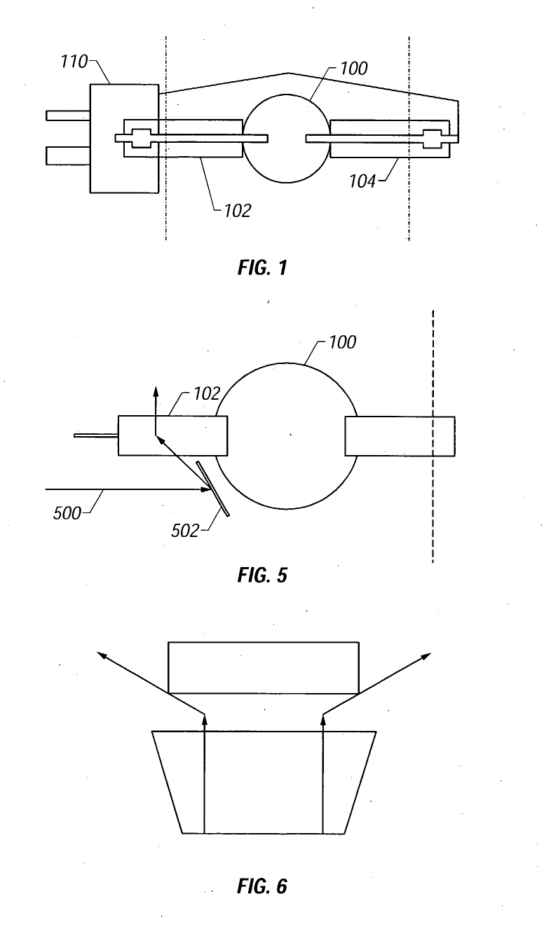

A bulb of the preferred type is shown in FIG. 1. This bulb has a central portion 100 which emits light, and edge portions 102, 104, at least one of which need to be cooled. The central portion 100, which emits the light, is preferably not cooled. The bulb used herein is called an MSR SA, or short arc discharge bulb. Other bulbs have similar cooling requirements.

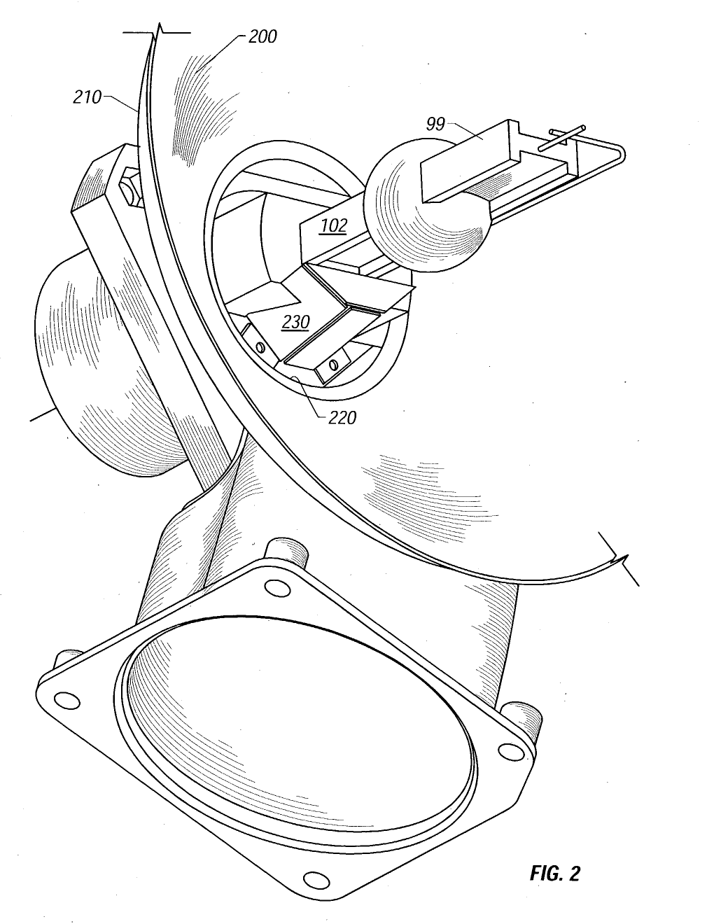

The edge portions 102, 104 should preferably be kept between 400 and 450° C. The bulb is mounted as shown in FIG. 2. When mounted in this way, the far edge portion 104 is often sufficiently cooled by ambient to be kept within the desired range. However, the near edge portion 102 gets very hot, due to the proximity to the ceramic base 110 and also because of its electrical connection. Also, as described above, cooling should not, or should only minimally, touch the center portion 100.

FIG. 2 shows the bulb 99 placed relative to a portion of the reflector 200. The base portion 110 of the bulb is shown connected. The reflector 200 includes an outer edge 210 and an inner edge 220. A metal air deflecting portion 230 fits within the inner edge 220, and directs air from a fan to the close pinch portion 102 of the bulb which is close to the reflector.

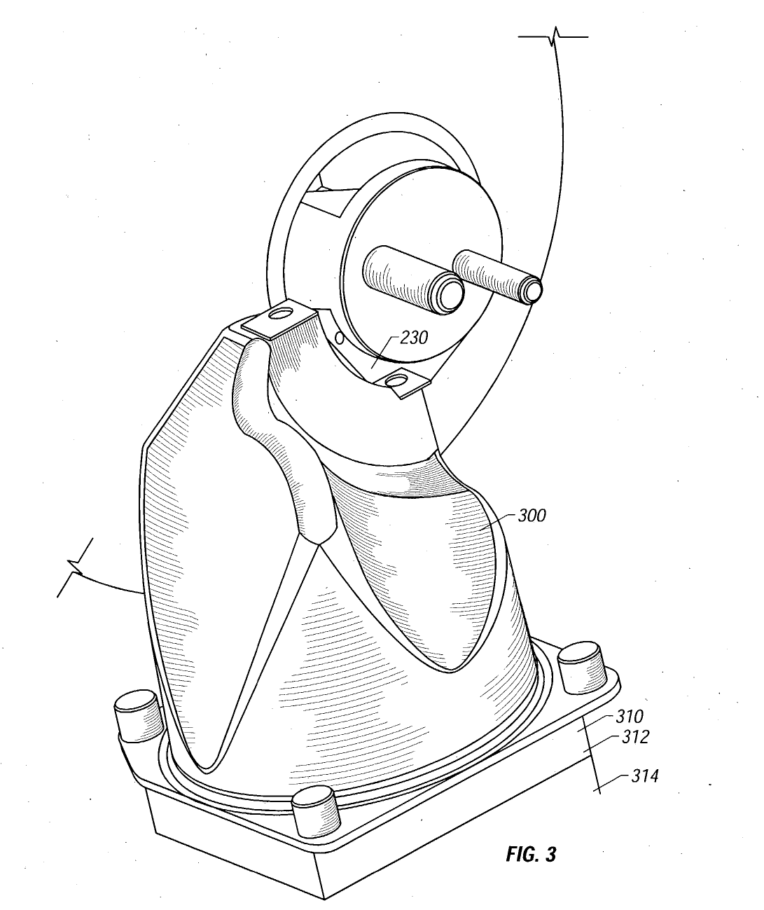

FIG. 3 shows the rear view of the system. An air chamber 300 is attached to a fan assembly shown generically as 310. The fan assembly 310 forces into the air assembly 300, and through the air coupling mechanisms 230, to eventually end up at the bulb. Further detail is shown in the other Figures.

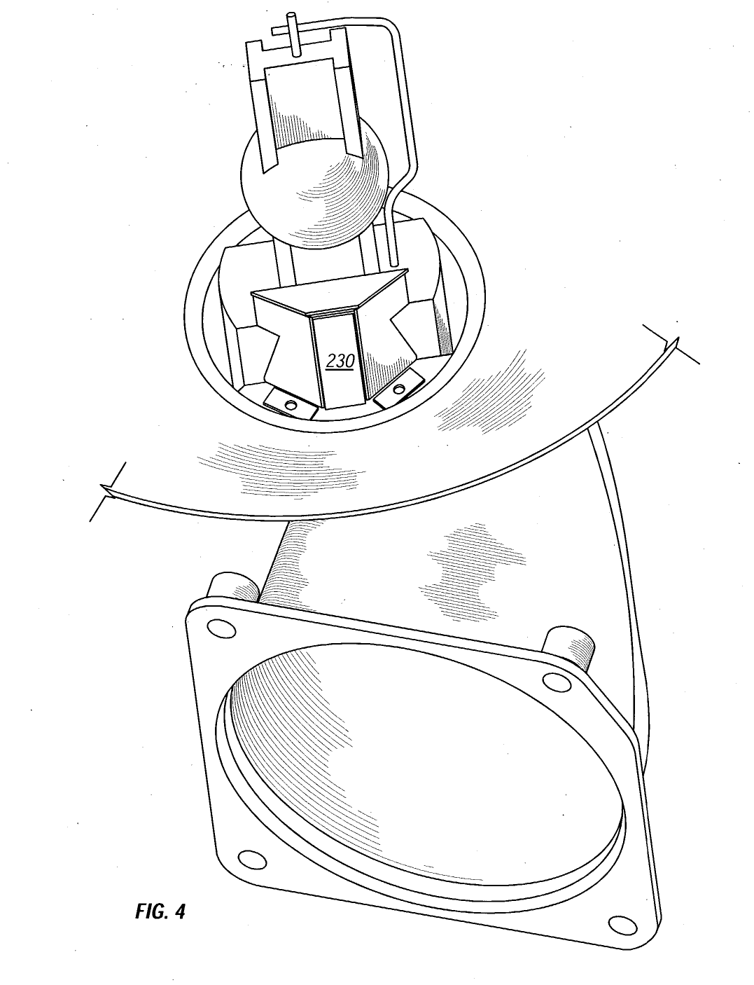

FIG. 4 shows more detail of the shape of the air deflection assembly. FIG. 5 shows schematically how the air is coupled. The air couples through the assembly as 500. It hits the far end wall 502 of the air coupling assembly 230. This air is then deflected back towards the near pinch 102, and travels thereover, cooling the near pinch 102 as it passes. The air is traveling away from the main portion of the bulb. In this system, the air preferably travels from the central portion towards the pinch.

FIG. 6 shows a cross-section along the line 5-5 in FIG. 5. The air travels outwardly, as shown, and hence again travels away from the pinch portion.

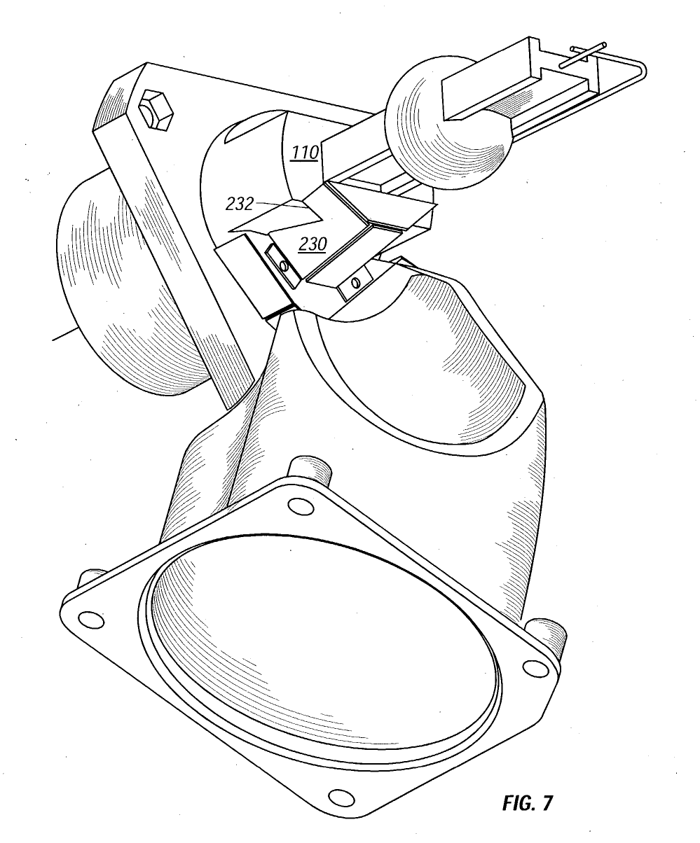

FIGS. 5 and 6 show the air chimney defined by the metal pieces 230. These pieces are aligned relative to the bulb. The alignment is shown in more detail in FIG. 7 which shows the air producing assembly 230, held in place relative to the bulb. The alignment can be via connection to the reflector in a way that holds the chimney relative to the desired cooled area of the bulb. It can be, alternatively, held by a clip that is placed around the bulb. The air producing assembly includes inner surfaces 232 which are adapted to press against the face 110, to hold the air deflection assembly in place relative to the bulb or the bulb's expected position.

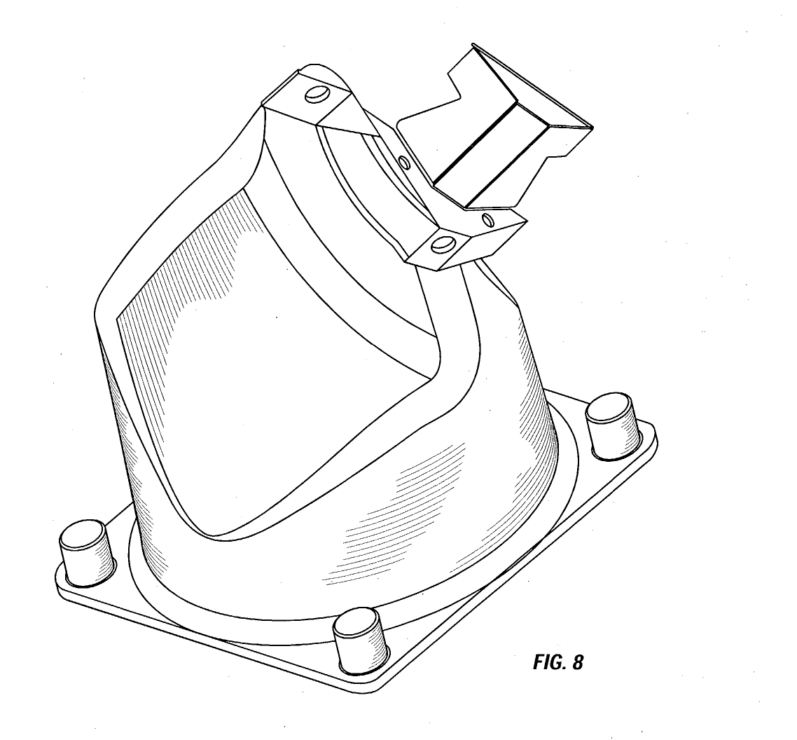

FIG. 8 shows a diagram of only the air producing assembly and the attachment to the air chimney. The fan assembly 310 comprises two separate fans mounted one on top of the other as shown. Fans 312 and 314 produce air at the same rate as one fan would have produced but at a higher air pressure.

Although only a few embodiments have been disclosed in detail, other embodiments are possible. All such modifications are intended to be encompassed within the following claims.

What is claimed is:

1. A method, comprising:
using a bulb with a reflector to project light along a specified direction; and
cooling one portion of said bulb without cooling an other portion of said bulb, while projecting light.

2. A method as in claim 1, wherein said cooling comprises forcing air across said one portion of said bulb in a direction generally away from said other portion of said bulb.

3. A method as in claim 1,.wherein said bulb includes two electrode portions, and a lighted portion between said two electrode portions, one of said electrode portions being cooled, and said lighted portion not being cooled.

4. A method as in claim 2, wherein said forcing air comprises forcing air along an axis, and deflecting the air from said axis towards said one portion of said bulb.

5. A method as in claim 2, wherein said forcing air comprises forcing air in a first direction toward said other portion of said bulb, and deflecting said air in a second direction, away from said other portion of said bulb, and toward said one portion of said bulb.

6. A method as in claim 1, wherein said cooling comprises cooling said one side of said bulb by forcing air in the direction from said one portion of said bulb.

7. A method as in claim 6, wherein said air is forced through an opening in said reflector.

8. A method as in claim 7, wherein said cooling comprises using a deflector to channel air in a way that does not interfere with reflection from said reflector.

9. A method as in claim 1, wherein said bulb extends generally along an axis, and one portion of said bulb is cooled, while another portion along said axis is not cooled.

10. A method as in claim 1, further comprising channeling air into a chamber that extends along an axis, and first directing said air in a direction generally along said axis, and deflecting said air in a direction generally at an angle with said axis, to a part to said one portion of said bulb without directing said air to said other portion of said bulb.

11. A lighting fixture, comprising:
a lighting reflector;
a lighting socket located within said lighting reflector;
a cooling air aperture, extending into an inside of said lighting reflector, and configured to cool only a specified area within said lighting reflector.

12. A fixture as in claim 11, wherein said aperture includes a deflecting portion, wherein air is passed along a specified axis in said deflecting portion, and then deflected by said deflecting portion into said specified area.

13. A fixture as in claim 11, further comprising a bulb, attached to said lighting socket, said bulb having a first cooled portion, and a second portion which is intended not to be cooled.

14. A fixture as in claim 12, further comprising a bulb, attached to said lighting socket, and extending along a specified axis, having a first portion along said axis which is intended to be cooled, and a second portion extending along said axis which is not intended to be cooled.

15. A fixture as in claim 13, wherein said bulb includes first and second electrode portions, and a lighted portion between said first and second electrode portions, said lighted portion being a portion which is not cooled in operation, and said electrode portions being portions which are cooled in operation.

16. A lighting fixture, comprising:
an optical reflector, having a first reflecting part, and a second non reflecting part;
a bulb socket, formed in said second non reflecting part; and
a cooling air chimney portion, extending from a first point outside said optical reflector, to a second point inside said optical reflector, and forming a channel for cooling air inside said optical reflector that is directed along a confined path, inside said chimney portion.

17. A fixture as in claim 16, wherein said chimney portion is formed of bent sheet metal.
